(19) United States
(12) Patent Application Publication
(10) Pub. No.: US 2002/0144527 A1
(43) Pub. Date: Oct. 10, 2002

(54) Lock actuator assembly

(76) Inventors: Troy A. Dalsing, Colorado Springs, CO (US); Frederick M. Hensley, Colorado Springs, CO (US)

Correspondence Address: MICHAEL BEST & FRIEDRICH LLP, 3773 CORPORATE PARKWAY, SUITE 360, CENTER VALLEY, PA, 18034-8217, US

(21) Appl. No.: 09/829,588

(22) Filed: Apr. 10, 2001

(51) Int. Cl. E05B 9/04

(52) U.S. Cl. 70/373; 70/375

(57) ABSTRACT

A lock actuation assembly for use in a lock chassis. The lock actuation assembly comprises a core and a driver. The core includes a tubular portion positionable in the lock chassis and including a passage therethrough. A flange extends through the tubular portion and is biasable to a position in which a driver engaging portion is within the passage and a projection engaging portion is within the tubular portion's extent. The driver includes a shaft configured to be received within the passage to operably engage the lock chassis' drive system and to engage the flange driver engaging portion such that the projection engaging portion is forced into engagement with a projection extending into the lock chassis core-receiving chamber.

### BACKGROUND

The present invention relates to lock chassis assemblies and more particularly to a disposable lock actuator assembly.

During a construction project, doors and related hardware are typically installed prior to completion of the project. The door hardware typically includes a lock set including a lock chassis adapted to receive an interchangeable, key-operated core. During the construction phase, some of the doors, for example perimeter doors and doors to storage areas, may require a key-operated core such that passage through the doors can be limited to individuals having the appropriate key. After the construction phase, these key-operated cores are typically “changed out” such that the building occupants receive new key sets, thereby reducing the risk of unauthorized access by individuals with unaccounted for keys.

The remaining doors, for example, most interior doors, do not require restricted passage. As such, key-operated cores in these doors are undesirable due to change out cost and the unnecessary restriction on free passage. However, some door actuation means is necessary to allow operation of the lock set, i.e., to allow opening of closed doors. To accommodate such, it is known to provide disposable lock actuators that are insertable into the lock chassis and operable without core specific keys. For example, see U.S. Pat. No. 4,843,852 to Foshee et al.

### SUMMARY

The present invention provides a lock actuation assembly for use in a lock chassis having a core-receiving chamber, a lug projection extending into the chamber, and a lock chassis drive system extending into the chamber. The lock actuation assembly comprises core and a driver. The core includes a front plate, a tubular portion and a flange. The front plate is configured to be received in and substantially close the chamber apart from a driver-receiving bore therethrough. The tubular portion extends rearwardly from the front plate co-axially with the bore such that the tubular portion and the bore define a passage alignable with the lock chassis drive system. The tubular portion is configured such that its outer extent can be received in the chamber without interfering with the projection. The flange extends inwardly through the tubular portion and includes a driver engaging portion and a projection engaging portion. The flange is biasable to a position in which the driver engaging portion is within the passage and the projection engaging portion is within the tubular portion's extents. The driver includes a shaft configured to be received within the passage to operably engage the lock chassis drive system and to engage the flange driver engaging portion such that the projection engaging portion is forced outwardly beyond the tubular portion extents and into engagement with the projection. The driver has a shape complementary to that of the passage such that it easily aligns with the lock chassis drive system.

### BRIEF DESCRIPTION OF THE DRAWINGS

FIG. 1 is an isometric, cross-sectional view of an illustrative lock chassis;

FIG. 2 is an exploded isometric view of the lock actuation assembly of the preferred embodiment of the present invention positioned for insertion into a lock chassis;

FIG. 3 is a front elevation view of the preferred core member of the present invention;

FIG. 4 is a plan view of the preferred core member in the direction of lines 4-4 in FIG. 3;

FIG. 5 is a cross-sectional view along the line 5-5 in FIG. 3;

FIG. 6 is a cross-sectional view along the line 6-6 in FIG. 4;

FIG. 7 is a rear elevation view of the preferred driver of the present invention;

FIG. 8 is a cross-sectional view along the line 8-8 in FIG. 7;

FIG. 9 is a front elevation view of the preferred driver of the present invention;

FIGS. 10, 13 and 16 are sectional views of the lock chassis and inserted core along the line 10-10 in FIG. 2 with the driver illustrated at various progressions of insertion;

FIGS. 11, 14 and 17 are sectional views of the lock chassis and inserted core along the line 11-11 in FIG. 10 with the driver illustrated at progressions corresponding respectively to those of FIGS. 10, 13 and 16;

FIGS. 12, 15 and 18 are sectional views of the lock chassis and inserted core along the line 12-12 in FIG. 10 with the driver illustrated at progressions corresponding respectively to those of FIGS. 10, 13 and 16.

### DETAILED DESCRIPTION OF THE PREFERRED EMBODIMENTS

The preferred embodiments of the present invention will be described with reference to the drawing figures wherein like numerals represent like elements throughout. Certain terminology, for example, “right”, “left”, “front”, “frontward”, “rear” and “rearward”, is used in the following description for relative descriptive clarity only and is not intended to be limiting.

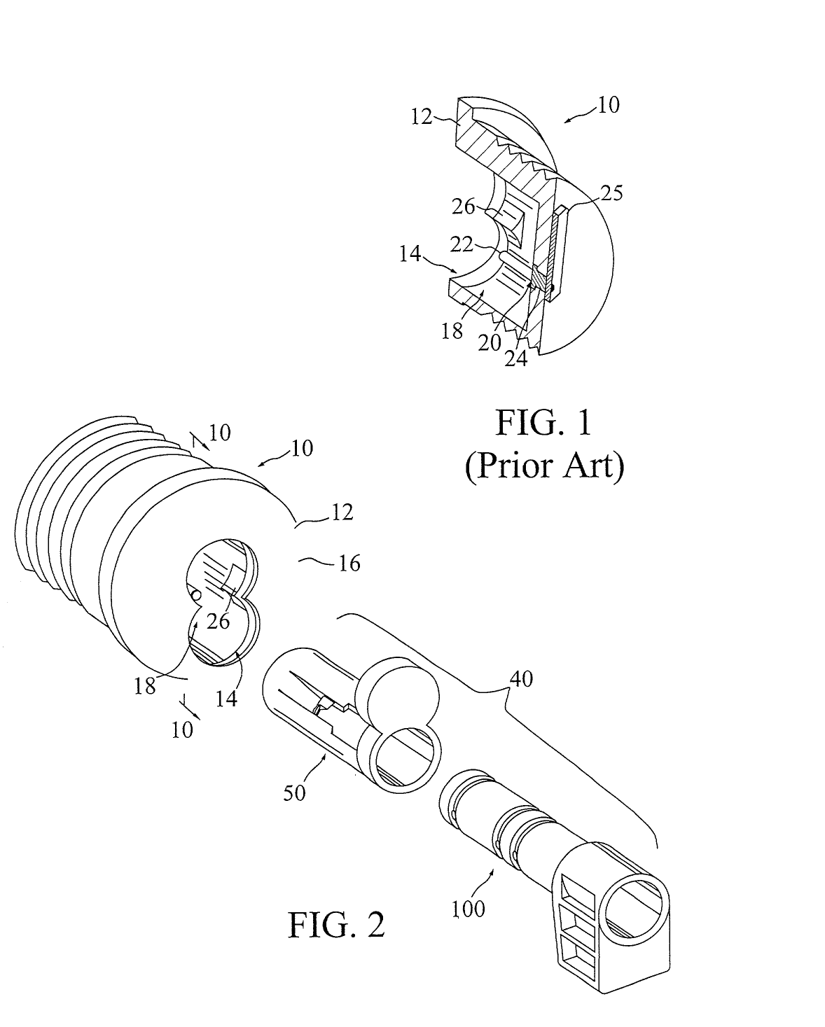

Referring to FIGS. 1 and 2, an illustrative lock chassis 10 will be described. The lock chassis 10 includes a cylinder 12 with an aperture 14 through its front face 16 to a core-receiving chamber 18. In the illustrated lock chassis 10, the aperture 14 has a “FIG. 8” configuration as this is the standard core configuration, however, other configurations may be utilized. A lock drive system 20 extends into the rear of the chamber 18. The standard lock drive system 20 includes pins 22 extending from a cam 24 which is in turn to a lock throw 26. Manipulation of the pins 22 is translated to the lock throw 26 to operate the lock set (not shown). The lock chassis 10 includes one or more control lug projections 26 extending into the core-receiving chamber 18 adjacent the aperture 14. The lug control projection 26 is a standard means of maintaining the permanent keyed core in the lock chassis 10. The permanent keyed core is positioned in the chamber 18 and then a designated key is used to extend a lug from the core which contacts the lug projection and maintains the core in position.

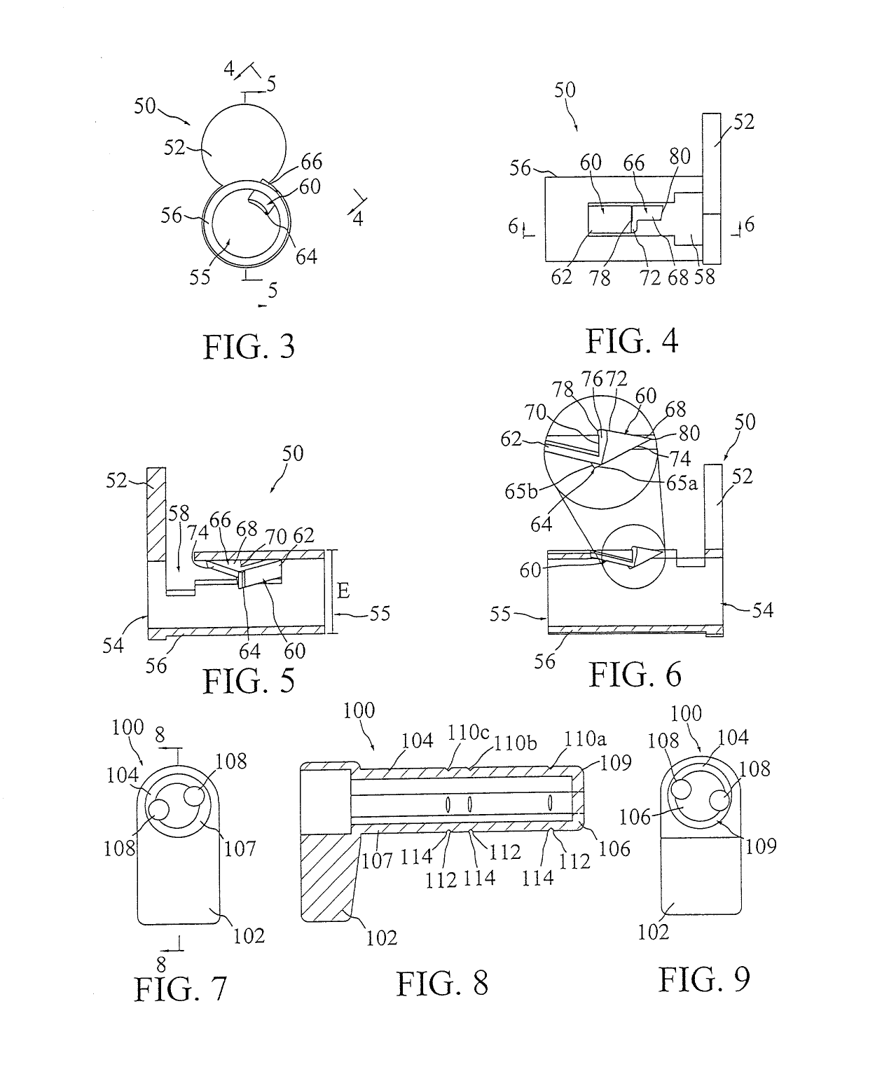

The preferred lock actuation 40 assembly of the present invention will be described with reference to FIGS. 2-9. The lock actuation assembly 40 generally comprises a core 50 and a driver 100. Referring to FIGS. 2-6, the core 50 includes a front plate 52 which is configured to be received in and substantially close the lock chassis aperture 14 apart from a driver-receiving bore 54 therethrough. The front plate 52 configuration complements that of the aperture 14, and therefore, the illustrated front plate 52 has a figure-8 configuration like that of the illustrative chassis aperture 14. A tubular portion 56 extends rearwardly from the front plate 52 and is co-axial with the bore 54. The tubular portion 56 and the bore 54 define a passage 55 that aligns with the pins 22 of the lock chassis drive system 20 when the core 50 is inserted into the chamber 18. The tubular portion 56 is sized and configured such that it can be received into the chamber 18 without its outer extents E interfering with the control lug projections 26, but with an opening 58 adjacent to one of the projections 26. In the preferred embodiment, the tubular portion 56 is circular to complement the lower half of the figure-8 shaped aperture 14 and chamber 18, however, other shapes are possible.

A flange 60 extends inwardly through the tubular open portion 58. The flange 60 includes an arm 62 having a driver engaging point 64 depending from its inward surface and a projection engaging block 66 extending from its outward surface. The arm 62 from the tubular portion 56 and is biased toward a position in which the driver engaging point 64 is within the passage 55 and the protrusion engaging block 66 is proximate the outward extents E of the tubular portion 56.

As can be seen in FIGS. 5 and 6, the engaging point 64 is defined by opposed angled surfaces 65a, 65b. The block 66 includes a generally triangular portion 68, defined by a rear surface 70, a top surface 72 and a diagonal surface 74 extending therebetween, and an arched reinforcement portion 76. The top surface 72 is substantially parallel to the outward surface of the arm 62 such that when the arm 62 is at its rest position, biased inward, the top surface 72 also slopes inward. The juncture between the rear surface 70 and the top surface 72 has a chamfered edge 78 and the juncture between the top surface and the diagonal surface 74 define an abutting surface 80. Referring to FIG. 12, it can be seen that the flange 60 is configured such that the abutting surface 80 is adjacent the rear contacting surface 27 of the projection 26 upon full insertion of the core 50 into the chamber 18.

Referring to FIGS. 2 and 7-9, the preferred driver 100 includes a handle 102 and a shaft 104 configured to be received within the passage 55. The shaft 104 extends from the handle 102 and terminates in a leading surface 106. A plurality of bores 108 extend through the leading surface 106 and the length of the shaft 104. The number and configuration of the bores 108 complements the number, size and positioning of the lock pins 22 such that the pins 22 are received into the bores 108 when the shaft 104 is inserted in a given orientation. The shaft 104 is preferably substantially hollow from the handle 102 to the leading surface 106 such that a user can see through the driver 100 to align the pins 22 if necessary. As shown in FIG. 7, the bores 108 preferably extend into the circumferential wall 107 of the shaft 104 such that the pins 22 are acted on by the shaft walls 107 in addition to the leading surface 106.

The shaft 104 includes a taper 109 adjacent the leading surface 106 and a plurality of spaced apart, outer peripheral grooves 110 a,b,c. Each groove 110 a,b,c is defined by intersecting tapered walls 112, 114. The grooves 110 a,b,c are configured to receive and engage the flange drive engaging point 64. The plurality of grooves 110 allows the drive 100 to be used with lock chassises 10 having different chamber depths due to, for example, the number of pins of the intended keyed core.

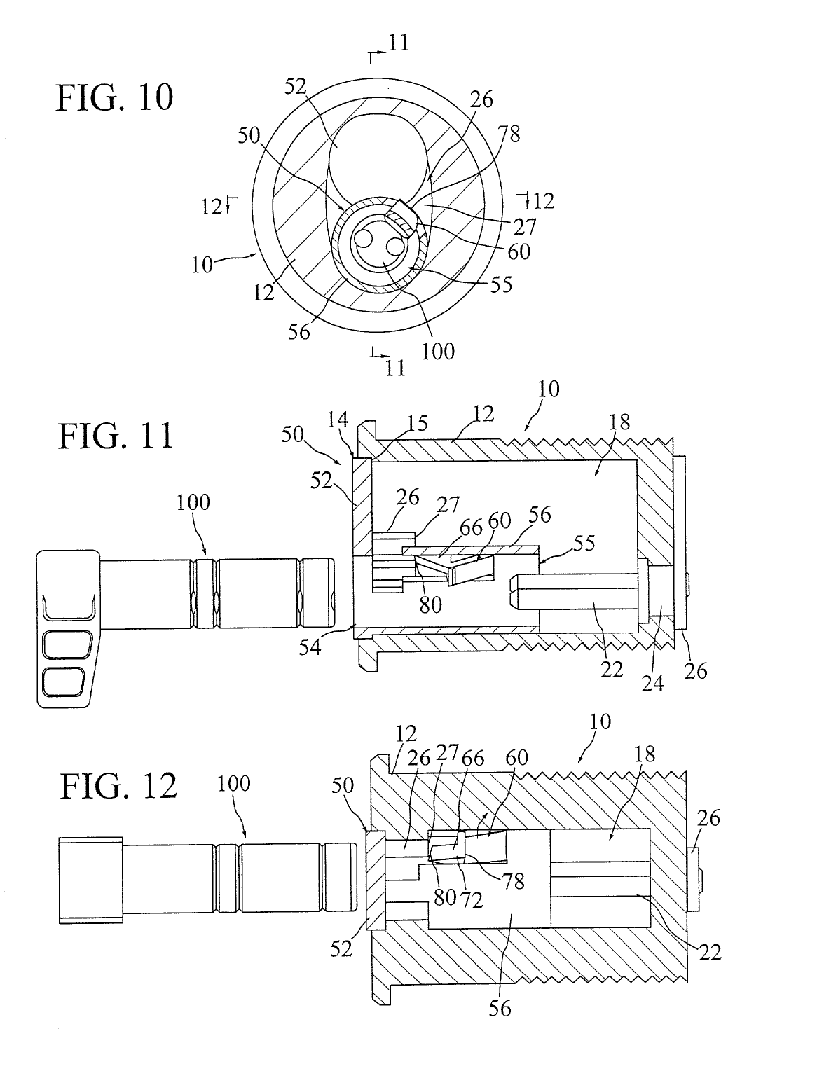

Having described the components of the preferred embodiment of the present invention, its operation will now be described with reference to FIGS. 10-18.

Referring to FIGS. 10-12, the core 50 is inserted through the aperture 14 and into the chamber 18 until the front plate 52 is received in the aperture 14 and contacts the aperture rim 15. As the core 50 is inserted, the chamfered edge 78 of the block 64 may contact the lug projection 26. The resiliency of the flange 60 allows it to flex inward as the projection 26 rides along the chamfered edge 68 and return to its original position once the chamfered edge 78 passes the projection 26. Upon complete insertion, the flange abutting surface 80 is aligned with the contact surface 27 of the projection 26, however, since the flange 60 is biased-inward, the abutting surface 80 is not in contact with the projection 26.

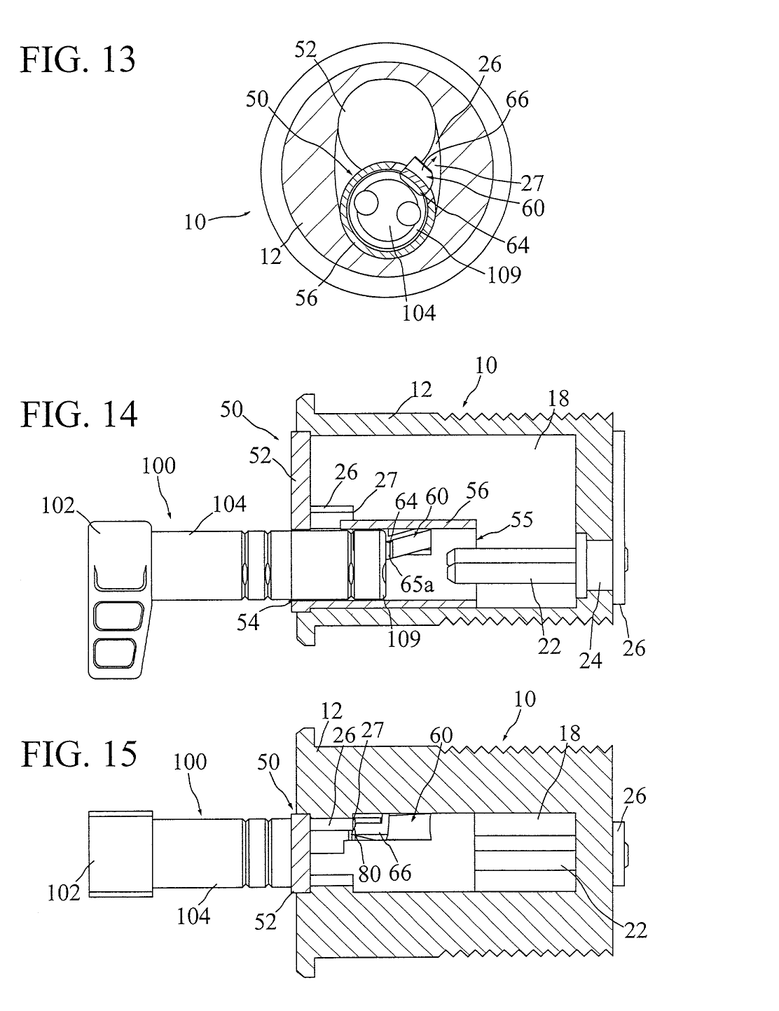

Referring to FIGS. 13-15, the driver 100 is inserted into the passage 55 defined by the bore 54 and tube 56. As the drive shaft 104 is inserted, the forward tapered surface 65a of the flange engaging point 64 rides up the taper 109 at the leading surface of the shaft 104 as the flange 60 flexes outward. The abutting surface 80 of the outwardly flexed flange 60 engages the contact surface 27 of the projection 26, thereby preventing removal of the core 50.

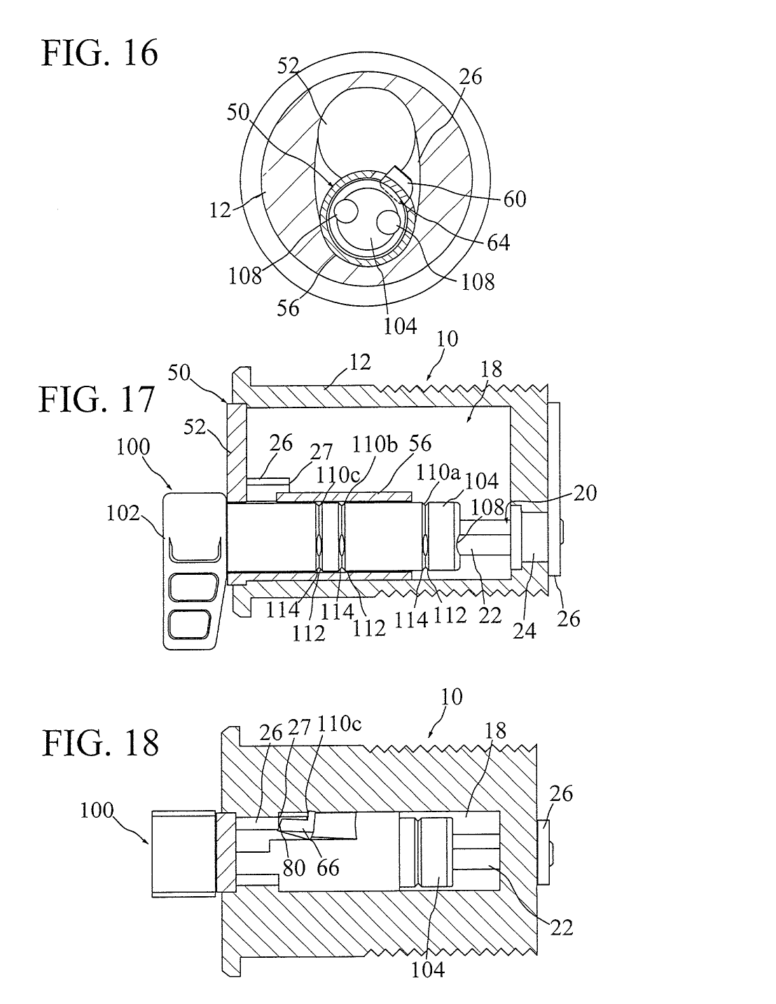

Referring to FIGS. 16-18, the driver shaft 104 is inserted the appropriate depth for the given core-receiving chamber 18 (in the illustrated embodiment, the driver is inserted completely). As the driver shaft 104 is inserted, the pins 22 are received in the bores 108. Since the tube 56 encircles the shaft 104, it prevents tilting of the shaft 104 out of alignment, and instead maintains axial alignment to allow easy engagement of the pins 22. As explained above, the hollow driver 100 allows a user to easily visually rotationally align the bores 108 with the pins 22 if needed. Also, as the shaft 104 is inserted, the driver engaging point 64 engages the appropriate peripheral groove 110. The tapered surfaces 112, 114, 65a, 65b of the grooves 110 and the point 64 allow the point 64 to engage and relatively easily disengage the forward grooves 110 a,b, for example, as the shaft 104 is completely inserted. Once the shaft 104 is inserted to the desired depth, the point 64 engages the respective groove 110c with sufficient rigidity to prevent inadvertent dislodging of the driver 100, but easily gives way upon a more substantial force to withdraw the shaft 104. With the shaft 104 inserted, a user can operate the lock chassis drive system 20 by simply turning the handle 102 which in turn causes rotation of the pins 22.

When it is time to remove the lock actuator 40, the driver 100 is removed by simply applying an outward.force. Again, the tapered surfaces 65a, 65b, 112, 114 allow the flange point 64 to ride out of the grooves 110 and give way to the withdrawal force. Upon removal of the shaft 104, the flange 60 resiliently returns to its inward position and the abutting surface 80 disengages the contact surface 27. In this position, the top surface 72 of the block 66 is sloped inward, see FIG. 12, such that as the core 50 is pulled out of the chamber 18, the flange 60 is moved inward to clear the projection 26 as it rides along the top surface 72. The lock actuator 40 can then be saved for future use or disposed of as desired. Due to its inexpensive manufacture and its lack of potential security breach, a thorough accounting of the actuators 40 is not necessary.

What is claimed is:

1. A lock actuation assembly for use in a lock chassis having an aperture opening into a rearwardly extending core-receiving chamber, a projection positioned proximate the aperture and extending into the chamber, and a lock chassis drive system extending into the chamber, the lock actuation assembly comprising;
a core including
a front plate configured to be received in and substantially close the aperture apart from a driver-receiving bore therethrough;
a tubular portion extending rearwardly from the front plate co-axially with the bore such that the tubular portion and the bore define a passage alignable with the lock chassis drive system, the tubular portion configured to have an outer extent that does not interfere with the projection;
a flange extending inwardly through the tubular portion, the flange including a driver engaging portion and a projection engaging portion, the flange being biasable to a position in which the driver engaging portion is within the passage and the projection engaging portion is within the tubular portion extent; and
a driver including a shaft configured to be received within the passage to operably engage the lock chassis drive system and to engage the flange driver engaging portion such that the projection engaging portion is forced outwardly beyond the tubular portion extents and into engagement with the projection.

2. The lock actuation assembly of claim 1 wherein the faceplate has a figure-8 configuration.

3. The lock actuation assembly of claim 1 wherein the tubular portion has a circular cross-section.

4. The lock actuation assembly of claim 3 wherein the driver shaft has a circular cross-section.

5. The lock actuation assembly of claim 1 wherein the projection engaging portion has a rearwardly facing chamfered edge.

6. The lock actuation assembly of claim 1 wherein the shaft has first and second ends and at least one bore extending therebetween.

7. The lock actuation assembly of claim 6 wherein the shaft is defined by a circumferential wall and the bore extends along and defines an axial recess in a portion of the wall.

8. The lock actuation assembly of claim 1 wherein the driver shaft has a tapered leading edge.

9. The lock actuation assembly of claim 1 wherein the driver shaft has first and second ends and at least one peripheral groove therebetween configured to receive a portion of the projection engaging portion.

10. A lock actuation assembly for use in a lock chassis having an aperture opening into a rearwardly extending core-receiving chamber and a lock chassis drive system including at least one pin extending into the chamber, the lock actuation assembly comprising;
a core positionable within the chamber and having a passage therethrough which is alignable with the lock system pin; and
a driver including a shaft configured to be received within the passage, the shaft having first and second ends and at least one bore, configured to receive the lock system pin, extending from one shaft end to the other.

11. The lock actuation assembly of claim 10 wherein the core includes a faceplate having a bore therethrough and a hollow tubular portion extending rearward from the faceplate co-axial with the bore to define the passage.

12. The lock actuation assembly of claim 11 wherein the faceplate has a figure-8 configuration.

13. The lock actuation assembly of claim 11 wherein the tubular portion has a circular cross-section.

14. The lock actuation assembly of claim 13 wherein the driver shaft has a circular cross-section.

15. The lock actuation assembly of claim 10 wherein the shaft is defined by a circumferential wall and the bore extends along and defines an axial recess in a portion of the wall.

16. The lock actuation assembly of claim 10 wherein the driver shaft has a tapered leading edge.

17. The lock actuation assembly of claim 10 wherein the driver shaft has at least one peripheral groove between the shaft ends.
